(19) United States
(12) Patent Application Publication
(10) Pub. No.: US 2020/0162345 A1
(43) Pub. Date: May 21, 2020

(54) METHOD, SYSTEM AND OPTIONS FOR MULTI-OPERATOR SERVICE LIFE CYCLE MANAGEMENT

(71) Applicant: Huawei Technologies Co., Ltd., Shenzhen (CN)

(72) Inventors: Ishan VAISHNAVI, Munich (DE); Wint Yi POE, Munich (DE)

(21) Appl. No.: 16/752,602

(22) Filed: Jan. 24, 2020

Related U.S. Application Data
(63) Continuation of application No. PCT/EP2017/068802, filed on Jul. 25, 2017.

(51) Int. Cl. H04L 12/24

(52) U.S. Cl. CPC H04L 41/50; H04L 41/14; H04L 41/042

(57) ABSTRACT

The present invention relates to managing a lifecycle of a managed entity inside an operator within a network slicing architecture. The managed entity is one amongst a sub-service or service, a NSI or slice, a NSSI or slice subnet and an infrastructure, and each one is respectively managed by a management function which provides the managed entity to a higher layer management function and is one amongst a SMF, a NSMF, a NSSMF and an IMF. The operator further comprises a delegation entity, which is configured to receive an incoming request from a customer outside the operator and/or from another operator, perform an analysis by analyzing the incoming request, delegate, based on the analysis, the incoming request to at least one of the management functions, and be an end-point providing a programmable interface into the operator in which it is hosted to any other entities external to said operator.

### TECHNICAL FIELD

The present invention relates to the field of wireless communications, and more particularly to a multi-operator service life cycle management within a network slicing architecture.

### BACKGROUND

Compared to the fourth generation (4G) mobile technology, in the fifth generation (5G), the devices and applications of the next generation network will support use cases with a very high diversity in terms of performance attributes, such as ultra-reliable communications for mission critical services, eHealth, public safety, real-time vehicle control, tactile Internet and connectivity for drones. In order to support services with such a diverse range of requirements, the architecture fitting all the solutions used in the 4G network will be not scalable for the myriad of different use cases. Thus, the network slicing concept is expected to be one of the key building blocks of the future 5G network according to the recent standardization agreements. Indeed, the current understanding of the 5G architecture is that each type of device or application will have its own architectural slice, which will be configured just for their requirements. The device or application will be provided by a slice owner and hosted by an operator, and the slice owner will be a vertical or an over-the-top provider of the device or application, so that the network slicing concept will enable a service-tailored network function provisioning scheme aiming in particular at vertical industries integration.

According to the technical report entitled: 3GPP TR 28.801, “Study on management and orchestration of network slicing for next generation network”, V1.0.0 (2017-03), a network slice is composed of a collection of logical network functions that supports the communication service requirements of particular use case(s). The main expected target of this slicing is the vertical industries. Therein, an operator can host multiple slices for different verticals supporting internet of things (IoT), video communications or vehicle-to-X (V2X) kinds of use cases. In order to make their offer attractive to a vertical, an operator must cover a rather large area. For example, a car making company (vertical) has cars sold in multiple countries. However, it is difficult for a car maker to get in contact with every operator in every single country, whereas this process is much easier for an operator that already has pre-existing contracts with other operators.

### SUMMARY

It is therefore an object of the present invention to make a slice-related business more attractive to verticals by allowing an operator unable to offer coverage into areas not covered by him to create and/or extend a slice-related service within other operator networks.

The object is achieved by the features of the independent claims. Further embodiments of the invention are apparent from the dependent claims, the description and the drawings.

According to a first aspect, the invention relates to a management function inside an operator management system, i.e., one or more operator management systems, within a network slicing architecture. The management function is configured to be one amongst a service management function (SMF), a network slice management function (NSMF), a network slice subnet management function (NSSMF) and an infrastructure management function (IMF), which are ordered from the highest layer management function to the lowest layer management function. The management function is configured to manage a respective managed entity being one amongst a sub-service or service when the management function is the SMF, a network slice instance (NSI) or slice when the management function is the NSMF, a network slice subnet instance (NSSI) or slice subnet when the management function is the NSSMF and an infrastructure when the management function is the IMF, the infrastructure comprising network functions (NFs), virtualized network functions (VNFs) and basic resources. And the management function is configured to provide the managed entity to a higher layer management function, the sub-service or service being provided from a service provider comprising the SMF to a customer outside the operator management system domain.

According to a further implementation form of the first aspect, the managed entity has a lifecycle management comprising a preparation phase, a deployment phase, a run-time phase and a de-commissioning phase. The preparation phase comprises a design sub-phase, an on-boarding sub-phase and a pre-provisioning sub-phase; the deployment phase comprises an instantiation sub-phase, a configuration sub-phase and an activation sub-phase; the run-time phase comprises a reporting and monitoring sub-phase and a supervision sub-phase; the de-commissioning phase comprises a de-activation sub-phase and a termination sub-phase.

The above object is also solved in accordance with a second aspect.

According to the second aspect, the invention relates to an operator management system within a network slicing architecture. The operator management system comprises at least one service management function (SMF) as claimed in the first aspect, at least one network slice management function (NSMF) as claimed in the first aspect, at least one network slice subnet management function (NSSMF) as claimed in the first aspect, at least one infrastructure management function (IMF) as claimed in the first aspect, and at least one delegation entity configured to receive an incoming request from a customer outside the operator management system domain as specified in the first aspect and/or from another operator management system, configured to perform an analysis by analyzing the incoming request, and configured to delegate, based on the analysis, the incoming request to a management function amongst the SMF, the NSMF, the NSSMF and the IMF. And the delegation entity is configured to be an end-point providing a programmable interface into the operator management system in which it is hosted towards any other entities external to said operator management system.

According to a further implementation form of the second aspect, any one of the management functions is collocated with any other management functions.

According to a further implementation form of the second aspect, the incoming request is at least one amongst a request for hosting a sub-service or service as specified in the first aspect, a request for a NSI or slice as specified in the first aspect, a request for a NSSI or slice subnet as specified in the first aspect, and a request for an infrastructure as specified in the first aspect. Further, the incoming request comprises any combination of arguments or parameters.

In particular, the request for hosting a sub-service or service during a pre-provisioning sub-phase as specified in an implementation form of the first aspect comprises any combination of arguments or parameters amongst, in a non-exhaustive enumeration, a network service descriptor (NSD), particular details of the service configured in the NSD, a service level agreement (SLA) to be met for the service and an identifier (ID) of an existing network service offer.

In particular, the request for hosting a sub-service or service during an instantiation sub-phase as specified in an implementation form of the first aspect comprises any combination of arguments or parameters amongst, in a non-exhaustive enumeration, a network service descriptor (NSD), particular details of the service configured in the NSD, a quality of service (QoS) class, a service level agreement (SLA) to be met for the service and an identifier (ID) of an existing network service offer.

In particular, the request for a NSI or slice during a pre-provisioning sub-phase as specified in an implementation form of the first aspect comprises any combination of arguments or parameters amongst, in a non-exhaustive enumeration, a network slice template (NST).

In particular, the request for a NSI or slice during an instantiation sub-phase as specified in an implementation form of the first aspect comprises any combination of arguments or parameters amongst, in a non-exhaustive enumeration, a network slice template (NST) or an identifier of the NST, a quality of service (QoS) class for the constituents of the NSI, a service level agreement (SLA) to be met for the service.

In particular, the request for a NSSI or slice subnet during a pre-provisioning sub-phase as specified in an implementation form of the first aspect comprises any combination of arguments or parameters amongst, in a non-exhaustive enumeration, a network slice subnet descriptor (NSSD) or an identifier (ID) of the NSSD.

In particular, the request for a NSSI or slice subnet during an instantiation sub-phase as specified in an implementation form of the first aspect comprises any combination of arguments or parameters amongst, in a non-exhaustive enumeration, an NSSD or an identifier of the NSSD, a quality of service (QoS) class, a service level agreement (SLA) to be met for the service, penalties for SLA violation.

In particular, the request for an infrastructure during a pre-provisioning sub-phase as specified in an implementation form of the first aspect comprises any combination of arguments or parameters amongst, in a non-exhaustive enumeration, the required resources or an identifier (ID) of the types of the resources, a quality of service (QoS) class and an amount of said resource types.

In particular, the request for an infrastructure during an instantiation sub-phase as specified in an implementation form of the first aspect comprises any combination of arguments or parameters amongst, in a non-exhaustive enumeration, the list of the resource types or an identifier (ID) of the list of resources, a collection of network functions, an associated reliability of the network functions, an amount of said resource types, an associated reliability of the computing resources and networking resources. More specifically, the networking resources comprise at least one of the following specifications amongst, in a non-exhaustive enumeration, a bandwidth, a delay, a storage, a computation, each of them associated to a QoS class, affinity constraints, anti-affinity constraints and geographical location constraints.

According to a further implementation form of the second aspect, the delegation entity delegates the incoming request to the SMF when the incoming request is a request for the sub-service or service, to the NSMF when the incoming request is a request for the NSI or slice, to the NSSMF when the incoming request is a request for the NSSI or slice subnet, to the IMF when the incoming request is a request for the infrastructure, and to at least one amongst the SMF, the NSMF, the NSSMF and the IMF when the incoming request is a request for at least one amongst the sub-service or service, the NSI or slice, the NSSI or slice subnet and the infrastructure, respectively.

The above object is also solved in accordance with a third aspect.

According to the third aspect, the invention relates to a system within a network slicing architecture. The system comprises at least one operator management system as claimed in the second aspect or any one of the implementation forms of the second aspect, and at least one customer outside the operator management system domain as specified in the second aspect. The at least one customer outside the operator management system domain comprises a respective service management function (SMF) as a respective customer SMF (CSMF), which manages a respective managed entity as a respective sub-service or service as specified in the first aspect, and the at least one customer outside the operator management system domain contacts the at least one operator management system by transmitting a respective incoming request as individually specified in the second aspect.

According to a further implementation form of the third aspect, for each operator management system, the management function managing the managed entity manages a lifecycle of the requested managed entity when the incoming request from the at least one customer outside the operator management system domain is a request for at least one managed entity as claimed in the first aspect which is transmitted towards at least one operator management system as claimed in the second aspect.

According to a further implementation form of the third aspect, the SMF of each operator management system manages a lifecycle of its requested sub-service or service when the incoming request from the at least one customer outside the operator management system domain is the request for a sub-service or service as specified in the first aspect which is transmitted from the at least one customer outside the operator management system domain towards at least two operator management systems.

According to a further implementation form of the third aspect, the NSMF of each operator management system manages a lifecycle of its requested NSI or slice when the incoming request from the at least one customer outside the operator management system domain is the request for a NSI or slice as specified in the first aspect which is transmitted from the at least one customer outside the operator management system domain towards at least two operator management systems.

According to a further implementation form of the third aspect, one of the management functions of the single operator management system processes and relays the request towards at least one second operator management system in the case where the first operator management system cannot totally fulfill the request, in order to allow the SMF of the at least one second operator management system to manage a lifecycle of the requested sub-service or service, when the incoming request from the at least one customer outside the operator management system domain is the request for a sub-service or service as specified in the first aspect which is transmitted from the at least one customer outside the operator management system domain towards a first operator management system.

According to a further implementation form of the third aspect, one of the management functions of the first operator management system processes and relays the request towards at least one second operator management system in the case where the first operator management system cannot totally fulfill the request, in order to allow the NSMF of the at least one second operator management system to manage a lifecycle of the requested NSI or slice, when the incoming request from the at least one customer outside the operator management system domain is the request for a NSI or slice as specified in the first aspect which is transmitted from the at least one customer outside the operator management system domain towards a first operator management system.

According to a further implementation form of the third aspect, one of the management function of the first operator management system processes and relays the request towards at least one second operator management system in the case where the first operator management system cannot totally fulfill the request, in order to allow the NSSMF of the at least second operator management system to manage a lifecycle of the requested NSSI or slice subnet, when the incoming request from the at least one customer outside the operator management system domain is the request for a NSSI or slice subnet as specified in the first aspect which is transmitted from the at least one customer outside the operator management system domain towards a first operator management system.

According to a further implementation form of the third aspect, the first operator management system processes and relays the request towards at least one second operator management system in the case where the first operator management system cannot totally fulfill the request, in order to allow the IMF of the at least one second operator management system to manage a lifecycle of the requested infrastructure, when the incoming request from the at least one customer outside the operator management system domain is the request for an infrastructure as specified in the first aspect which is transmitted from the at least one customer outside the operator management system domain towards a first operator management system.

According to a further implementation form of the third aspect, each NSMF is configured to on-board at least one network slice template (NST) allowing each NSMF to deploy and manage at least one NSI as specified in the first aspect, each NST is identified using the NST itself or a respective first identifier (ID) identifying the at least one NST, each NSSMF is configured to on-board a respective network slice subnet descriptor (NSSD) allowing each NSSMF to deploy and manage a respective NSSI as specified in the first aspect, each NSSD is identified using the NSSD itself or a respective second identifier (ID); and the resources managed by each IMF are identified using a respective resource description or a respective third identifier (ID).

The above object is also solved in accordance with a fourth aspect.

According to the fourth aspect, the invention relates to a method for managing a lifecycle of a managed entity within a network slicing architecture. The method comprises the step of receiving, at an operator management system as specified in an implementation form of the second aspect, an incoming request from a customer outside the operator management system domain as specified in an implementation form of the second aspect and/or from another operator management system, wherein the incoming request is at least one amongst a request for hosting or providing a sub-service or service, a request for a NSI or slice, a request for a NSSI or slice subnet, a request for an infrastructure and a request for a combination thereof. The method further comprises the steps of performing an analysis by analyzing the incoming request and delegating, based on the analysis, the incoming request to a management function configured to manage the managed entity.

According to a further implementation form of the fourth aspect, the method further comprises the step of managing the lifecycle of the managed entity hosted at the operator management system receiving the incoming request.

According to a further implementation form of the fourth aspect, the method further comprises the step of relaying the delegated incoming request towards an operator management system other than the operator management system receiving the incoming request, the step of performing another analysis by analyzing the relayed incoming request, the step of delegating, based on the analysis of the relayed incoming request, the relayed incoming request to a management function entity of the other operator management system being configured to manage the managed entity, and the step of managing the lifecycle of the managed entity hosted at the other operator management system receiving the relayed incoming request.

According to a further implementation form of the fourth aspect, the step of managing the lifecycle of the managed entity comprises a preparation phase, which comprises a design sub-phase, an on-boarding sub-phase and a pre-provisioning sub-phase, a deployment phase, which comprises an instantiation sub-phase, a configuration sub-phase and an activation sub-phase, a run-time phase, which comprises a reporting and monitoring sub-phase and a supervision sub-phase, and a de-commissioning phase, which comprises a de-activation sub-phase and a termination sub-phase.

The above object is also solved in accordance with a fifth aspect.

According to the fifth aspect, the invention relates to a computer program comprising a program code for performing the method according to the fourth aspect or any one of the implementation forms of the fourth aspect when executed on a computer.

Thereby, the method can be performed in an automatic and repeatable manner.

The computer program can be performed by the above apparatuses.

More specifically, it should be noted that all the above apparatuses may be implemented based on a discrete hardware circuitry with discrete hardware components, integrated chips or arrangements of chip modules, or based on a signal processing device or chip controlled by a software routine or program stored in a memory, written on a computer-readable medium or downloaded from a network such as the Internet.

It shall further be understood that a preferred embodiment of the invention can also be any combination of the dependent claims or above embodiments with the respective independent claim.

These and other aspects of the invention will be apparent and elucidated with reference to the embodiments described hereinafter.

### BRIEF DESCRIPTION OF THE DRAWINGS

In the following detailed portion of the present disclosure, the invention will be explained in more detail with reference to the exemplary embodiments shown in the drawings, in which:

FIGS. 1a-b show a preparation flow illustrating the interfaces between the management functions during the preparation phase of the lifecycle of a network slice, according to an embodiment of the present invention;

FIG. 2 shows a table (denoted as Table 1) describing the arguments for on-boarding inquiry, according to an embodiment of the present invention;

FIG. 3 shows a table (denoted as Table 2) describing the arguments for pre-provisioning, according to an embodiment of the present invention;

FIG. 4 shows a deployment flow illustrating the interfaces between the management functions during the instantiation sub-phase of the deployment phase of the lifecycle of a network slice, according to an embodiment of the present invention;

FIG. 5 shows a table (denoted as Table 3) describing the arguments for instantiation, according to an embodiment of the present invention;

FIG. 6 shows a deployment flow illustrating the interfaces between the management functions during the configuration sub-phase of the deployment phase of the lifecycle of a network slice, according to an embodiment of the present invention;

FIG. 7 shows a table (denoted as Table 4) describing the arguments for configuration, according to an embodiment of the present invention;

FIG. 8 shows a deployment flow illustrating the interfaces between the management functions during the activation sub-phase of the deployment phase of the lifecycle of a network slice, according to an embodiment of the present invention;

FIG. 9 shows a table (denoted as Table 5) describing the arguments for activation, according to an embodiment of the present invention;

FIGS. 10a-b show a run-time flow illustrating the interfaces between the management functions during the reporting-monitoring sub-phase of the run-time phase of the lifecycle of a network slice, according to an embodiment of the present invention;

FIG. 11 shows a table (denoted as Table 6) describing the arguments for reporting and monitoring, according to an embodiment of the present invention;

FIG. 12 shows a run-time flow illustrating the interfaces between the management functions during the supervision sub-phase of the run-time phase of the lifecycle of a network slice, according to an embodiment of the present invention;

FIG. 13 shows a table (denoted as Table 7) describing the arguments for supervision, according to an embodiment of the present invention;

FIG. 14 shows a schematic block diagram of an operator receiving an external slice-related service request from a customer and/or another operator, according to an embodiment of the present invention; and

FIGS. 15a-f show multiple schematic block diagrams (numbered from 15a to 15f) illustrating a customer transmitting an incoming request towards at least one operator (A, B), according to an embodiment of the present invention.

Identical reference signs are used for identical or at least functionally equivalent features.

### DETAILED DESCRIPTION OF EMBODIMENTS OF THE INVENTION

Within the present invention, a network slice, also designated as slice, will be defined as a collection of interconnected logical access network functions including core network functions capable of meeting a diverse range of requirements.

In addition, business roles will be played by a customer, a service provider, a slice provider, a partial slice provider and an infrastructure provider.

The customer may be defined as a final customer whose role is to request and own the service. Then, the customer may, for example, sell the service to service end-users. The customer may comprise a customer service management function (CSMF) as a management function. The CSMF entity may be configured to manage the service as a managed entity.

The service provider may play the same role as a traditional operator by providing a sub-service or service as well as the virtualized network functions (VNFs) and the complete design of the sub-service itself to the customer. The service provider may comprise a service management function (SMF) as a management function. The SMF may be configured to manage the sub-service or service as a managed entity.

The role of the slice provider may be to create and operate the slice and provide it to the service provider. The slice provider may comprise a network slice management function (NSMF) as a management function. The NSMF may be configured to manage a network slice instance (NSI) or slice as a managed entity.

The role of the partial slice provider may be to provide parts of the slice to the slice operator. The partial slice provider may comprise a network slice subnet management function (NSSMF) as a management function. The NSSMF may be configured to manage a network slice subnet instance (NSSI) or slice subnet as a managed entity, the NSSI or slice subnet being a part of the NSI or slice.

The role of the infrastructure provider may be similar to that of the owner of the actual physical infrastructure. The infrastructure provider may comprise an infrastructure management function (IMF) as a management function. The IMF may be configured to manage an infrastructure as a managed entity, by managing and orchestrating the network functions (NFs), the virtualized network functions (VNFs) and the basic physical or virtual resources (e.g., compute, storage and networking). It should be noted that, in an actual implementation, the IMF could be any entity that orchestrates or manages a physical or virtual infrastructure such as, but not limited to, an element manager (EM), a domain manager, a network manager and an enterprise manager as defined by 3GPP TS 32.101, and a network functions virtualization orchestrator (NFVO) as defined by ETSI GS NFV-MAN 001 (v.1.1.1).

As regards the relationship between the aforementioned business roles, the customer may purchase sub-services or services from multiple service providers. The service provider may purchase NSIs or slices from multiple slice providers. The slice provider may purchase NSSIs or slice subnets from multiple partial slice provider. The partial slice provider may purchase infrastructures from multiple infrastructure providers.

It should be noted that the management functions (i.e., CSMF, SMF, NSMF, NSSMF, IMF and delegation function) may be separate or grouped. If grouped, the individual functionalities inside a group of management functions may then be combined into a single functionality.

The lifecycle of a NSI or (network) slice may be sequentially described by a preparation phase, a deployment phase, a run-time phase and a de-commissioning phase.

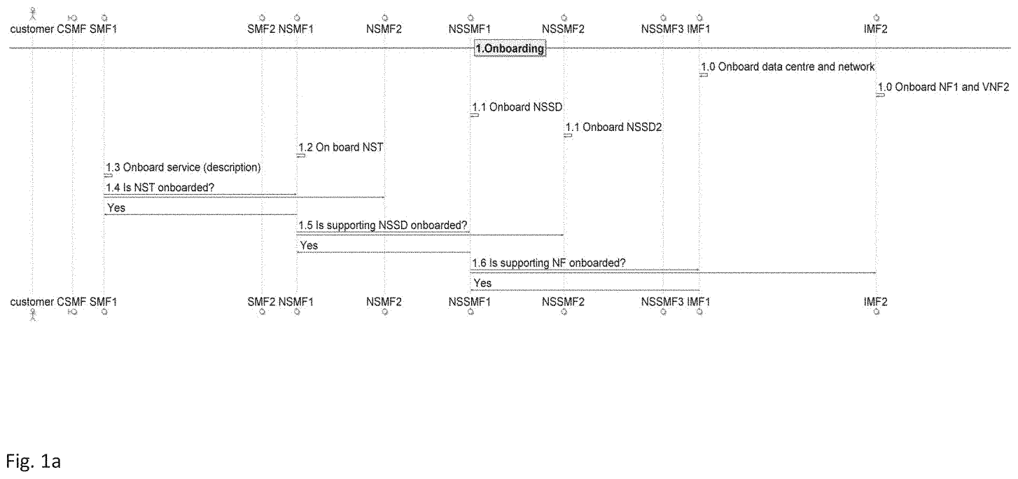

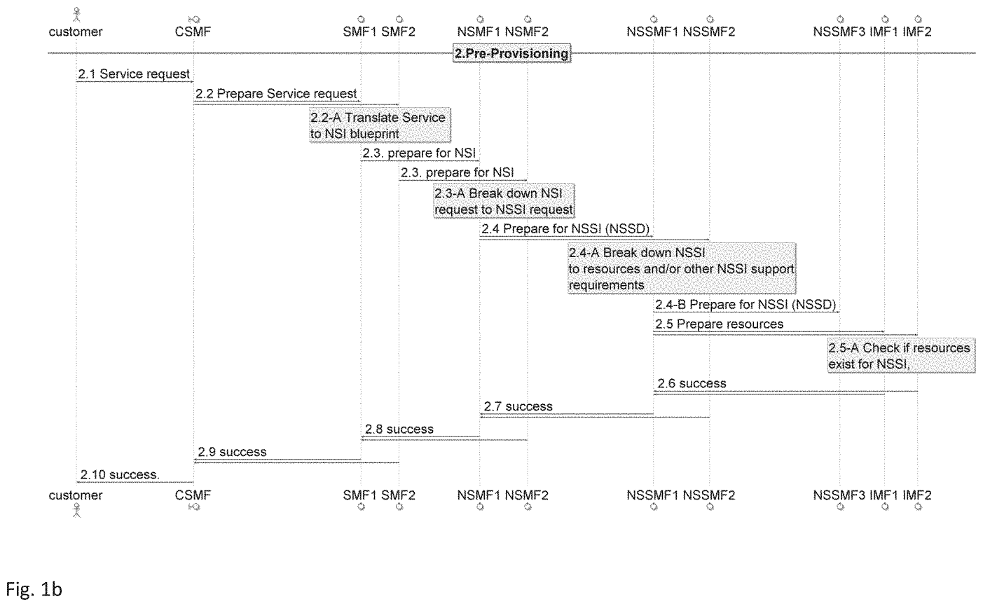

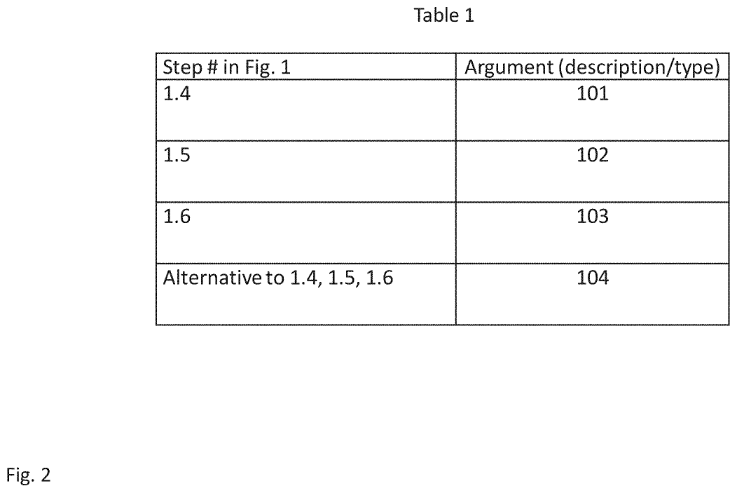

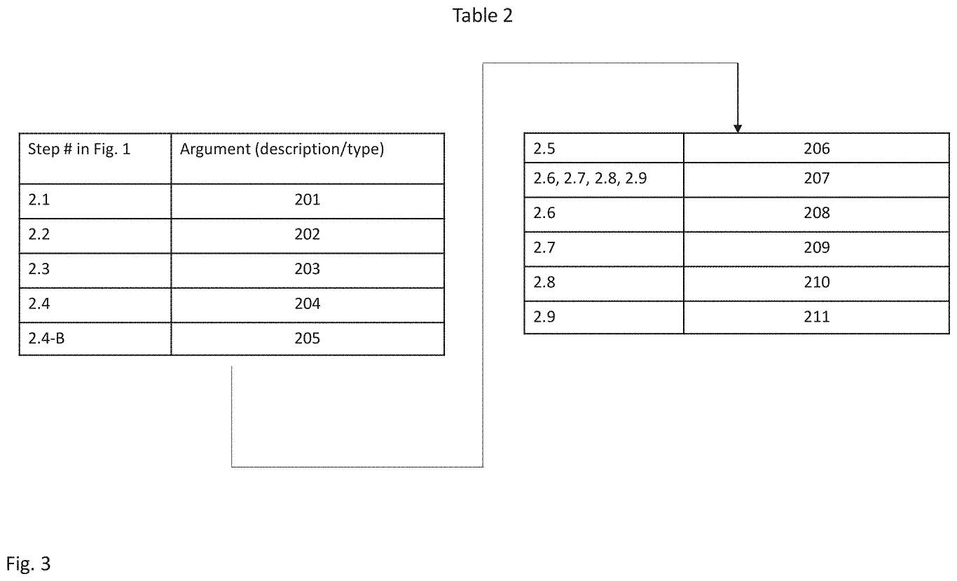

FIGS. 1 a-b show a preparation flow illustrating the interfaces between the management functions during the preparation phase of the lifecycle of a network slice, according to an embodiment of the present invention.

The preparation phase comprises three sub-phases: the design phase (not discussed here as external to the operator), the on-boarding phase (steps 1.0 to 1.6) and the pre-provisioning phase (steps 2.1 to 2.9).

During the preparation phase, mainly all the checks as to whether hosting the NSI as well as a reservation of the associated resources required to host the service, the NSI and the service management plane are suitable are performed. However, the reservation is only performed for a specified or default timeout after which the associated resources may be freed.

The sequences of the on-boarding and pre-provisioning phases of the preparation phase are illustrated in FIGS. 1a-b.

Within the on-boarding phase of the preparation phase, any one of the following depicted steps may happen irrespective of the sequence:
each IMF (IMF1, IMF2) may on-board a respective infrastructure such as NFs, VNFs, and basic virtual or physical resources (step 1.0). This means that the IMF is able to manage said infrastructure and that the authenticity and validity of the execution of the resources in the managed infrastructure is verified;
each NSSMF (NSSMF1, NSSMF2) may on-board a respective network slice subnet descriptor (NSSD) (step 1.1). This means that the NSSMF has verified and checked the NSSD, and knows, based on the NSSD, how to deploy and manage an NSSI;
each NSMF (NSMF, NSMF2) may on-board a respective network slice template (NST) (step 1.2). This means that the NSMF has verified and checked the NST, and knows, based on the NST, how to deploy and manage an NSI; and
each SMF may on-board a respective new service description (step 1.3).

As a part of any on-boarding, the higher layer management function may inquire whether the supporting parts are on-boarded in the lower management functions. Thus, an SMF may inquire from the NSMF whether the NSI of a given service is on-boarded (step 1.4), and similarly, an NSMF may inquire from an NSSMF whether the NSSI supporting an NSI is on-boarded (step 1.5) and the NSSMF may inquire from the IMF whether the infrastructure (i.e., NFs, VNFs, resources) supporting the NSSI is on-boarded (step 1.6). There are no restrictions as regards the sequencing of such inquiry.

FIG. 2 shows a table (denoted as Table 1) describing the arguments for on-boarding inquiry, according to an embodiment of the present invention.

Referring to block 101 of Table 1, the argument or parameter for the enquiry at step 1.4 may be defined as a way to identify the NST and may be the NST itself or an identifier (ID) of the NST.

Referring to block 102 of Table 1, the argument or parameter for the enquiry at step 1.5 may be defined as a way to identify the NSSD and may be the NSSD itself or an identifier (ID) of the NSSD.

Referring to block 103 of Table 1, the argument or parameter for the enquiry at step 1.6 may be defined as a way to identify the resource(s) and may be a resource description or collection of features (e.g., type, location) of the resource(s) or an identifier (ID) of the resource(s).

Referring to block 104 of Table 1, the higher management function may alternatively ask for a list of all supported NSTs (step 1.4), NSSDs (step 1.5) and infrastructures (NFs, VNFs, resources) (step 1.6). The lower function provides the list and the higher management function may check whether the members of the list are supported.

Within the pre-provisioning phase of the preparation phase, for each of the steps 2.2 to 2.5-A, the step before that step is optional. This implies, for example, that the step 2.5 may be initiated by the NSSMF itself irrespective of the steps 2.4 and/or 2.4-A, or that the step 2.5-A is performed by the respective IMF irrespective of whether the step 2.5 happened. Similarly, the step 2.1 is optional because the pre-provisioning phase may start after a service request or may be initiated by the CSMF. Optionally, the pre-provisioning phase may or may not be triggered by the on-boarding phase.

The pre-provisioning phase mainly checks at every level of management function whether that level and the lower level are able to support the instantiation of said management functions. If not, an appropriate preparation for the level at issue is performed by the respective management function.

FIG. 3 shows a table (denoted as Table 2) describing the arguments for pre-provisioning, according to an embodiment of the present invention.

Referring to block 201 of Table 2, the argument or parameter for requesting the service at step 2.1 may be related to a parameterized service description and may, for example, be a network service descriptor (NSD) as disclosed in the group specification (GS) entitled: “ETSI GS NFV-MAN 001 V.1.1.1 (2014-12)”. The parameterization implies that the requirements of the specific service instance are populated in the NSD. As above-mentioned, the step 2.1 is optional because the pre-provisioning phase may start after a service request or may be initiated by the CSMF.

Referring to block 202 of Table 2, the argument or parameter for preparing the service request at step 2.2 may be related to a parameterized service description of the composing (sub-) service to be managed by the respective SMF. The parameterization is only likely when the step 2.1 occurred. This step 2.2 is optional for the steps 2.2-A to 2.7, but required for the above step (i.e., step 2.1).

Referring to block 203 of Table 2, the argument or parameter for preparing the NSI at step 2.3 may be a parameterized NST describing the NSI that will support the (sub-) service of the step 2.2 to be managed by the respective NSMF. The parameterization is only likely when the step 2.1 occurred. This step 2.3 is optional for the steps 2.3-A to 2.6, but required for the above steps (i.e., steps 2.1 to 2.2-A).

Referring to block 204 of Table 2, the argument or parameter for preparing the NSSI at step 2.4 may be a parameterized NSSD describing the NSSI that will support the (sub-) service of the step 2.2 to be managed by the respective NSSMF. The parameterization is only likely when step 2.1 occurred. This step 2.4 is optional for the steps 2.4-A to 2.5-A, but required for the above steps (i.e., steps 2.1 to 2.3-A).

Referring to block 205 of Table 2, the argument or parameter for preparing the NSSI at step 2.4-B may be a parameterized NSSD describing the NSSI that will support the (sub-) service of the step 2.2 to be managed by the respective NSSMF. The parameterization is only likely when step 2.1 occurred. This step 2.4-B is optional for the steps 2.4-A to 2.5-A, but required for the steps 2.1 to 2.3, and also 2.4 if the NSSI at step 2.4 consists of another NSSI. It should be noted that the step 2.4-B reflects that an NSSI can be recursively composed so that an NSSMF may also request itself or another NSSMF recursively for preparing the composed NSSI.

Referring to block 206 of Table 2, the argument or parameter for preparing the resources at step 2.5 may be the identifiers of the types of the resource and possibly the quality of service (QoS) requirements and the amount of resources if the step 2.1 has been executed. The step 2.5-A of checking whether resources exist for NSSI is optional.

Referring to block 207 of Table 2, the argument or parameter for returning a success or a failure at steps 2.6 to 2.9 may be a return to lower level parameters of preparation in order to help with the preparation at higher level, and the failure may in all cases return the reason for failure.

Referring to block 208 of Table 2, at step 2.6., the return is related to the infrastructures, namely the resources, the NFs and the VNFs, and in particular to the types of resources, the QoS available, the locations that could host the resources, the types of NFs and VNFs available and the locations that could possibly host the NFs and VNFs.

Referring to block 209 of Table 2, at step 2.7, the return is related to the NSSIs, and in particular to the types of NSSIs available to support the NSIs at the NSMFs, the details on the NSSI locations, the coverage area and the supported users amongst others.

Referring to block 210 of Table 2, at step 2.8, the return is related to the NSIs, and in particular to the types of NSIs available to support the (sub-) services at the SMFs, the details on the NSI locations, the coverage area and the supported users amongst others.

Referring to block 211 of Table 2, at step 2.9, the return is related to the (sub-) services, and in particular to the types of (sub-) services available to support the services at the CSMFs.

In an alternative embodiment, the preparation request may also be seen as a request to gather from the lower layer management functions data on how to support at best the managed entity at the higher layer and then as a request to allow the higher layer management functions to make prioritizations and/or suggestions to the lower layer management functions on how to select the best options for that particular managed entity.

The deployment phase of an NSI comprises three sub-phases: the instantiation phase (steps 3.0 to 3.10), the configuration phase (steps 4.0 to 4.10) and the activation phase (steps 5.0 to 5.10). It should be noted that the separation of these sub-phases is merely logical and that, in practise, they may be executed in a single execution phase.

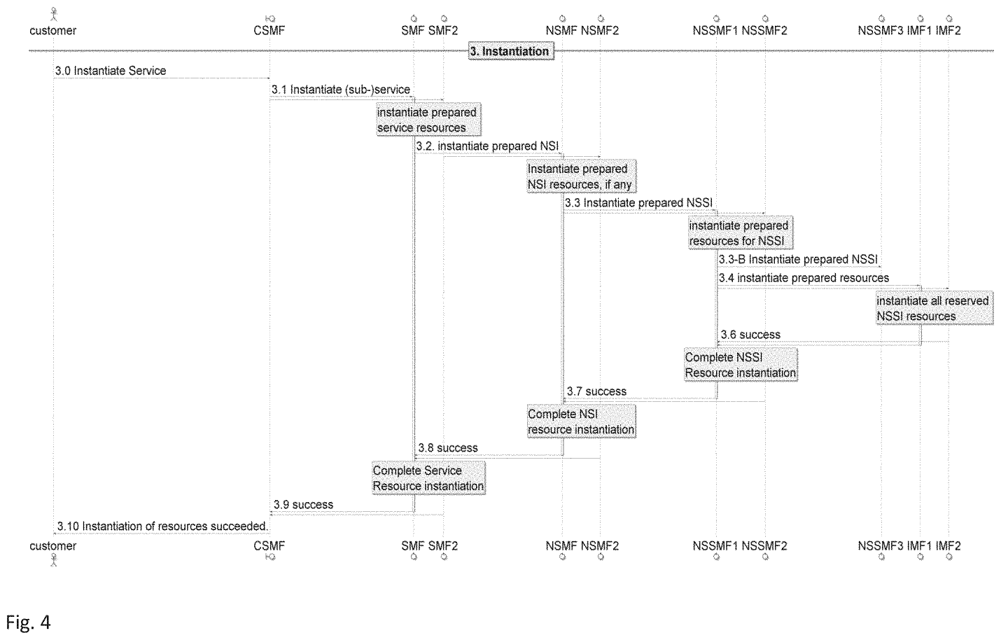

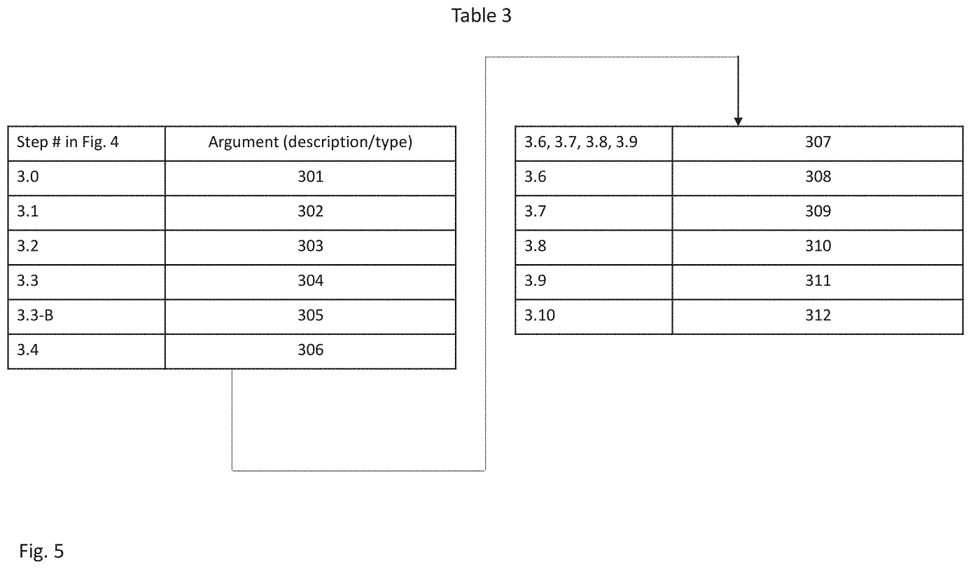

FIG. 4 shows a deployment flow illustrating the interfaces between the management functions during the instantiation sub-phase of the deployment phase of the lifecycle of a network slice, according to an embodiment of the present invention.

The instantiation phase is mainly responsible for creating all the resource structures without actually starting the service. For example, the virtual machine (VM) may be created and deployed in the correct location whereas the VM (or the VNF inside) has not started.

FIG. 5 shows a table (denoted as Table 3) describing the arguments for instantiation, according to an embodiment of the present invention.

Referring to block 301 of Table 3, the argument or parameter for requesting a service instantiation at step 3.0 may be a parameterized service description using, for example, a NSD or an identifier to the parameterized service description of the step 2.1. The parameterization implies that the requirements of the specific service instance are populated in the NSD, and a reference to the prepared NSD may be included.

In an alternative embodiment, the request to install the service may combine the steps 3.1 (service instantiation), 4.1 (service configuration) and 5.1 (service activation).

Referring to block 302 of Table 3, the argument or parameter for requesting a service instantiation at step 3.1 may be defined as a parameterized service description of the composing (sub-) service to be managed by the respective SMF or an identifier to the parameterized service description of the step 2.1. The parameterization is required for instantiation and may include the number of users to be supported and the QoS and service level agreement (SLA) to be provided. Moreover, a reference to the prepared NSD may be included. This step 3.1 is required for all the following steps (i.e., steps 3.2 to 3.10).

Referring to block 303 of Table 3, the argument or parameter for instantiating the prepared NSI at step 3.2 may be the parameterized NST describing the NSI that will support the (sub-) service of the step 3.1 to be managed by the respective NSMF or an identifier (ID) to the parameterized NST if provided in the pre-provisioning phase. The parameterization includes the number of users to be supported and the QoS and SLA to be provided. A reference to the prepared NST may be included. This step 3.2 is required for all the following steps.

Referring to block 304 of Table 3, the argument or parameter for instantiating the prepared NSSI at step 3.3 may be the parameterized NSSD describing the NSSI that will be a part of the NSI of the step 3.2 to be managed by the respective NSSMF or an identifier (ID) to the parameterized NSSD if provided in the pre-provisioning phase. The parameterization includes the number of users to be supported and the QoS and SLA to be provided, and a reference to the prepared NSSD may be included. This step 3.3 is required for all the following steps (i.e., steps 3.3-B to 3.10).

Referring to block 305 of Table 3, the argument or parameter for instantiating the prepared NSSI at step 3.3-B may be the parameterized NSSD describing the NSSI that will be a component of the NSSI of the step 3.3 or the step 3.3-B to be managed by the respective NSSMF or an identifier (ID) to the parameterized NSSD if provided in the pre-provisioning phase. The parameterization includes the number of users to be supported and the QoS and SLA to be provided, and a reference to the prepared NSSD may be included. This step 3.3-B is required only if the NSSI of the step 3.3 or 3.3-B is further composed of NSSI. It should be noted that this step 3.3-B reflects that an NSSI can be recursively composed so that an NSSMF may also request itself or another NSSMF recursively for preparing the composed NSSI.

Referring to block 306 of Table 3, the argument or parameter for instantiating the prepared resources at step 3.4 may be the identifiers (IDs) of the actual resources, types, numbers and possibly the QoS requirements and the amount of resources as well. This can be expressed as a resource graph. This step 3.4 is required.

Referring to block 307 of Table 3, the argument or parameter for returning a success or failure at steps 3.6 to 3.9 may be a return to lower level parameters of instantiation in order to help with the instantiation at higher level. The parameters include the location and addresses of the management element at each level, the access point as well and the access credentials. After each of these steps, the management function receiving the success request may further instantiate the managed function at its level based on the parameters received from the request, and the failure may in all cases return the reason for failure.

Referring to block 308 of Table 3, at step 3.6., the return is related to the infrastructures, namely the resources, the NFs and the VNFs. Regarding the resources, the return is related to the types of instantiated resources, the location addresses the access points, the connectivity details, the access credentials, and the management and service access points. Regarding the NFs and VNFs, the return is related to the types of instantiated NFs and VNFs, the location addresses, the access credentials, and the management and service access points.

Referring to block 309 of Table 3, at step 3.7, the return is related to the NSSIs, and in particular to the instantiated NSSIs, the locations, the coverage area, the number of users supported and the related identifiers (IDs).

Referring to block 310 of Table 3, at step 3.8, the return is related to the NSIs, and in particular to the instantiated NSIs, the locations, the coverage area, the number of users supported and the related identifiers (IDs).

Referring to block 311 of Table 3, at step 3.9, the return is related to the instantiated (sub-) services, and in particular to the service access and configuration points.

Referring to block 312 of Table 3, the argument or parameter for returning a succeeded instantiation at step 3.10 may be service-related information about the service access points, the users that are supported, the locations and the coverage areas. This step 3.10 is optional and is only required if explicit information on the instantiation of the service is requested.

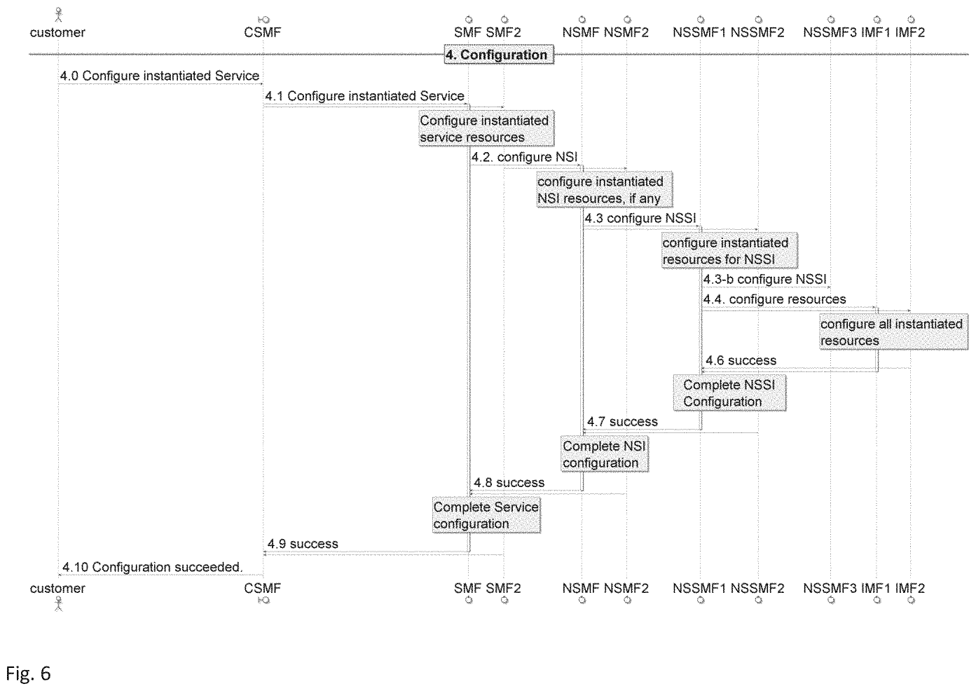

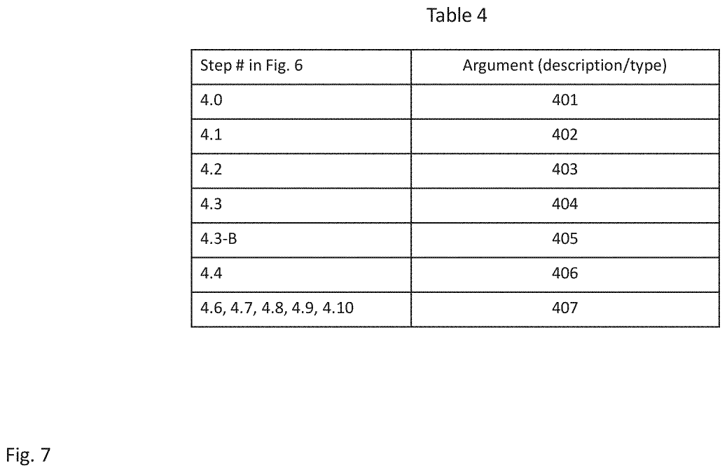

FIG. 6 shows a deployment flow illustrating the interfaces between the management functions during the configuration sub-phase of the deployment phase of the lifecycle of a network slice, according to an embodiment of the present invention.

The configuration of a service request is typically initiated by the customer owning the service request. However, it may also be generated at any level and at any time by any one of the management functions at any level. In addition, it may be generated by the management function at an upper level on request of a lower layer management function asking for a reconfiguration based on monitored key performance indicators (KPIs) of the managed element at that level.

FIG. 7 shows a table (denoted as Table 4) describing the arguments for configuration, according to an embodiment of the present invention.

Referring to respective blocks 401 and 402 of Table 4, the argument or parameter for configuring a service at steps 4.0 and 4.1 may be an identifier (ID) of the service and the configuration parameters. This includes access control parameters, end user details (such as subscriber identity module (SIM) card numbers), service-related data (such as media contents for a content delivery network (CDN) service). Essentially, this request configures the service's control and data plane (CP, DP) with control and data plane-related configuration.

Referring to block 403 of Table 4, the argument or parameter for configuring the prepared NSI at step 4.2 may be an identifier (ID) of the NSI and the configuration parameters of the NSI. This includes access control information of the NSI from end users as well as from other operators. Essentially, this request configures the service's control and data plane with control and data plane-related configuration.

Referring to block 404 of Table 4, the argument or parameter for configuring the NSSI at step 4.3 may be an identifier (ID) of the NSSI and the related configuration parameters.

Referring to block 405 of Table 4, the argument or parameter for instantiating the prepared NSSI at step 4.3-B may be an identifier (ID) of the NSSI and the related configuration parameters. This step 4.3-B is required only if the NSSI in the steps 4.3 or 4.3-B is further composed of NSSI. It should be noted that step reflects that an NSSI can be recursively composed so that an NSSMF may also request itself or another NSSMF recursively for preparing the composed NSSI.

Referring to block 406 of Table 4, the argument or parameter for configuring the prepared resources at step 4.4 may be the access control rights to the resources, the precise connectivity details together with the ID of the resource graph (e.g., virtualized network function forwarding graph (VNFFG)).

Referring to block 407 of Table 4, the argument or parameter for returning a success or failure at steps 4.6 to 4.10 may be the returned success or failure, and the failure may in all cases return the reason for failure. After each one of the steps, the management function receiving the success request may further configure the managed function at its level based on the success or failure of the configuration at a lower level.

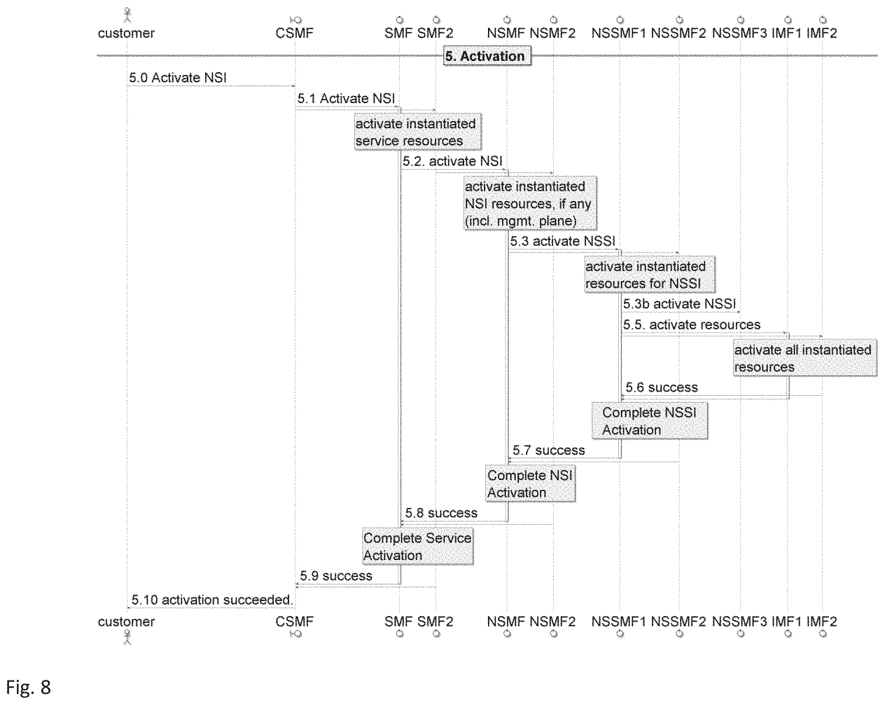

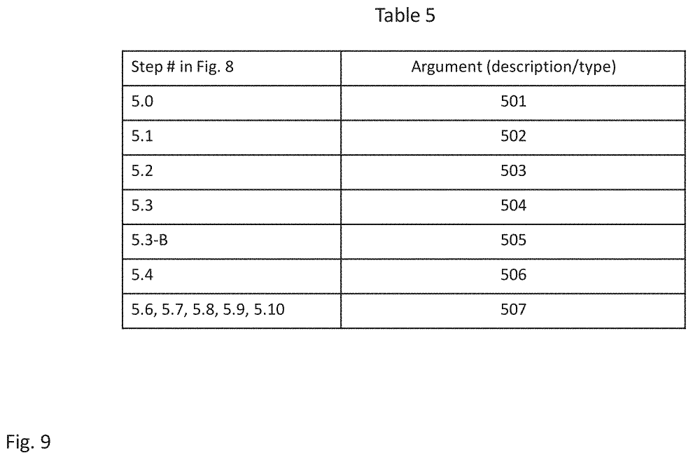

FIG. 8 shows a deployment flow illustrating the interfaces between the management functions during the activation sub-phase of the deployment phase of the lifecycle of a network slice, according to an embodiment of the present invention.

Once the steps of the instantiation phase (steps 3.0 to 3.10) and configuration phase (steps 4.0 to 4.10) achieved, the service is ready to be activated.

The activation phase is the final phase in actually running the service. After this phase has been executed, the service end-users can see the service running and access the service-related data in the respective data plane. A customer will usually activate a service after he has checked all service-related configuration and respective costs for the same.

FIG. 9 shows a table (denoted as Table 5) describing the arguments for activation, according to an embodiment of the present invention.

Referring to block 501 of Table 5, the argument or parameter for activating the service at step 5.0 may be an identifier (ID) of the service. This step 5.0 is required.

Referring to block 502 of Table 5, the argument or parameter for activating the service at step 5.1 may be an identifier (ID) of the service.

Referring to block 503 of Table 5, the argument or parameter for activating the NSI at step 5.2 may be an identifier (ID) of the NSI.

Referring to block 504 of Table 5, the argument or parameter for activating the NSSI at step 5.3 may be an identifier (ID) of the NSSI.

Referring to block 505 of Table 5, the argument or parameter for activating the NSSI at step 5.3-B may be an identifier (ID) of the NSSI. This step 5.3-B is required only if the NSSI in the step 4.3 or 4.3-B is further composed of NSSI. It should be noted that this step 5.3-B reflects that an NSSI can be recursively composed so that an NSSMF may also request itself or another NSSMF recursively for preparing the composed NSSI.

Referring to block 506 of Table 5, the argument or parameter for running the resources at step 5.4 may be an identifier (ID) of the resource and as the run-time parameters for NFs, VNFs, VMs as well as the respective connection parameters.

Referring to block 507 of Table 5, the argument or parameter for returning a success or failure at steps 5.6 to 5.10 may be the returned success or failure, and the failure may in all cases return the reason for failure. After each one of the steps, the management function receiving the success request may further activate other managed functions based on the success or failure of the activation at a lower level.

The run-time phase comprises two sub-phases: the reporting-monitoring phase (steps 6.0 to 6.15) and the supervision phase (steps 7.0 to 7.9) consisting of upgrade, reconfiguration and scaling.

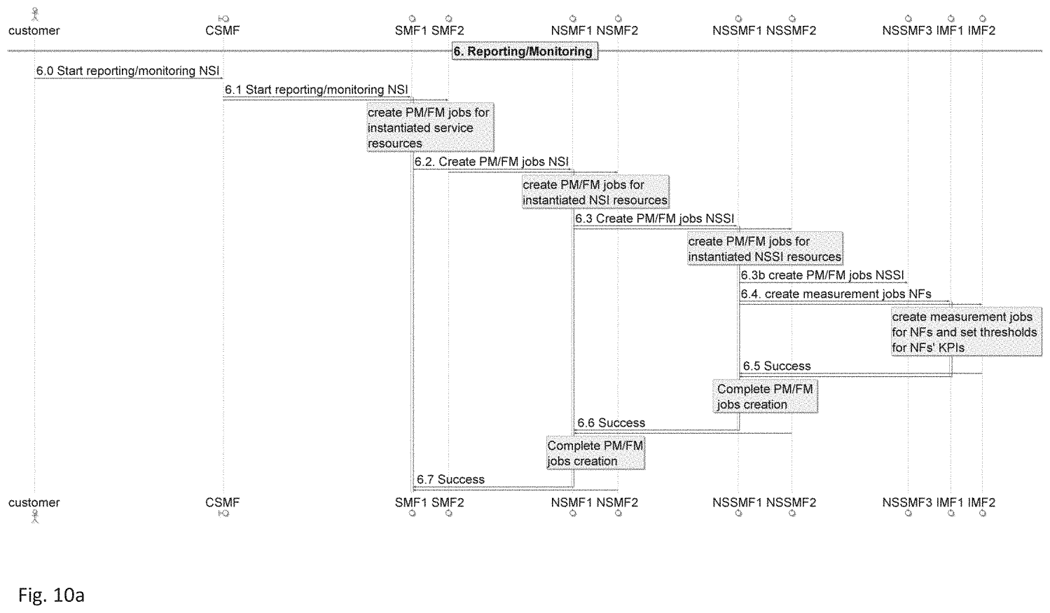

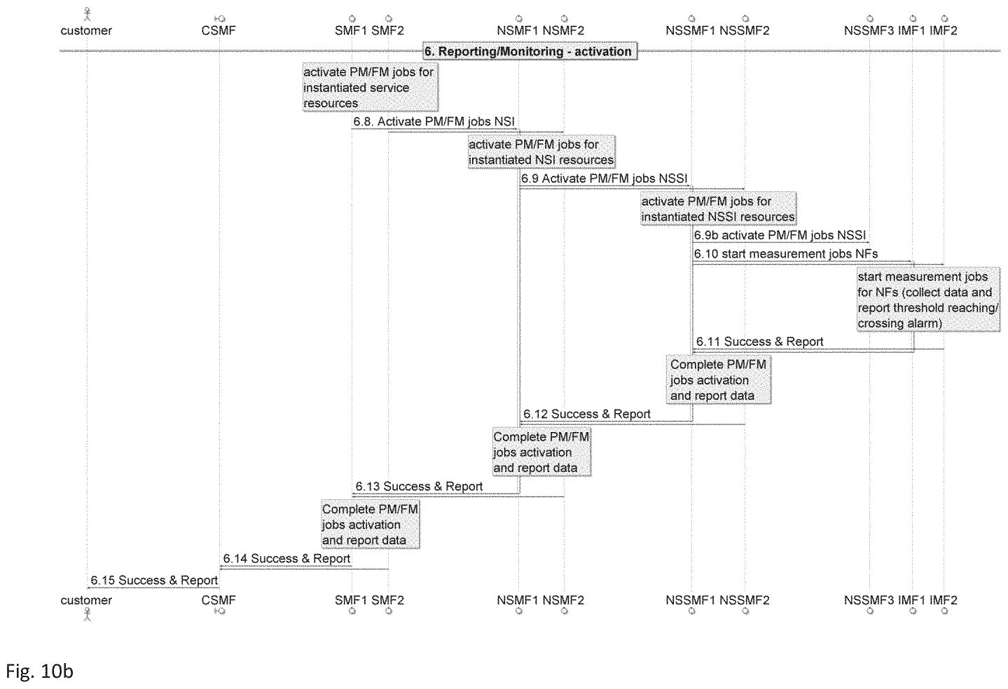

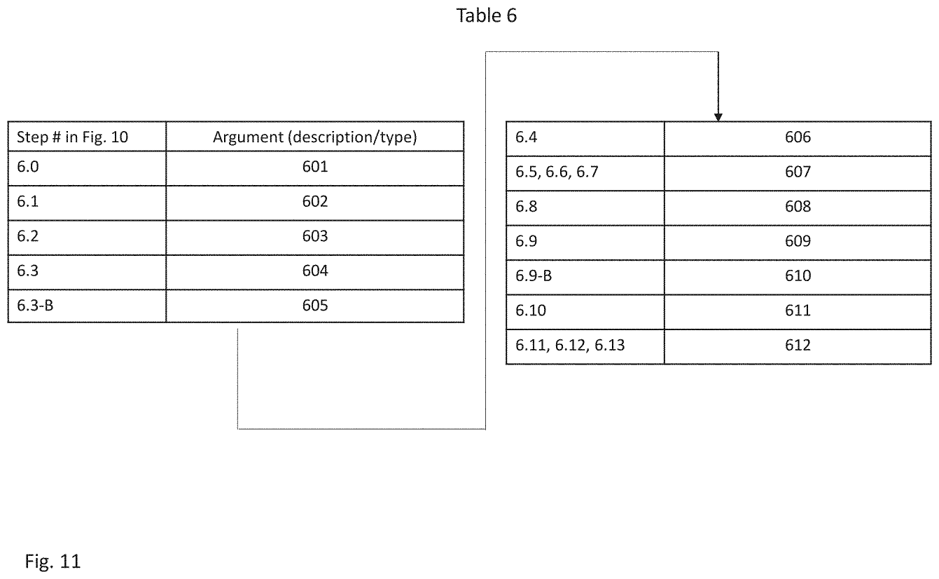

FIGS. 10a-b show a run-time flow illustrating the interfaces between the management functions during the reporting-monitoring sub-phase of the run-time phase of the lifecycle of a network slice, according to an embodiment of the present invention.

The reporting-monitoring phase follows immediately the activation phase. This phase consists of the performance as well as fault management functions. Based on the reported data, SLA reports are handed over to the customer. Any management function may issue a monitoring request and these requests may or may not be dependent on the received KPI values.

FIG. 11 shows a table (denoted as Table 6) describing the arguments for reporting and monitoring, according to an embodiment of the present invention.

Referring to block 601 of Table 6, the argument or parameter for starting to report and monitor a NSI at step 6.0 may be an identifier (ID) of the service. This step 6.0 is required.

Referring to block 602 of Table 6, the argument or parameter for starting to report and monitor a NSI at step 6.1 may be an identifier (ID) of the service.

Referring to block 603 of Table 6, the argument or parameter for creating performance management (PM)/fault management (FM) jobs NSI at step 6.2 may be an identifier (ID) of the NSI.

Referring to block 604 of Table 6, the argument or parameter for creating performance management (PM) and/or fault management (FM) jobs NSSI at step 6.3 may be an identifier (ID) of the NSI and/or the NSSI.

Referring to block 605 of Table 6, the argument or parameter for creating performance management (PM) and/or fault management (FM) jobs NSSI at step 6.3-B may be an identifier (ID) of the NSI and/or the NSSI. This step 6.3-B is required only if the NSSI in the step 4.3 or 4.3-B is further composed of NSSI. It should be noted that this step 6.3-B reflects that an NSSI can be recursively composed so that an NSSMF may also request itself or another NSSMF recursively for preparing the composed NSSI.

Referring to block 606 of Table 6, the argument or parameter for creating measurement jobs NFs at step 6.4 may be an identifier (ID) of the NSI, the NSSI, the NSSI NF, the NF KPI, the KPI threshold, the data reporting model, and the data pulling frequency amongst others.

Referring to block 607 of Table 6, the argument or parameter for returning a success or failure at steps 6.5 to 6.7 may be the returned success or failure for the measurement/PM/FM jobs, and the failure may in all cases return the reason for failure. After each one of the steps, the management function receiving the success request may further activate other managed functions based on the success or failure of the activation at a lower level.

Referring to block 608 of Table 6, the argument or parameter for activating PM/FM jobs NSI at step 6.8 may be an identifier (ID) of the PM/FM jobs.

Referring to block 609 of Table 6, the argument or parameter for activating PM/FM jobs NSSI at step 6.9 may be an identifier (ID) of the PM/FM jobs.

Referring to block 610 of Table 6, the argument or parameter for activating PM/FM jobs NSSI at step 6.9-B may be an identifier (ID) of the PM/FM jobs. This step 6.9-B is required only if the NSSI in the step 4.3 or 4.3-B is further composed of NSSI. It should be noted that this step 6.9-B reflects that an NSSI can be recursively composed so that an NSSMF may also request itself or another NSSMF recursively for preparing the composed NSSI.

Referring to block 611 of Table 6, the argument or parameter for starting measurement jobs NFs at step 6.10 may be an identifier (ID) of the measurement jobs.

Referring to block 612 of Table 6, the argument or parameter for returning a success or failure and reporting at steps 6.11 to 6.13 may be the returned success or failure, and the report of the measurement data will follow with the success. The failure may in all cases return the reason for failure. After each one of the steps, the management function receiving the success request may further activate other managed functions based on the success or failure of the activation at a lower level.

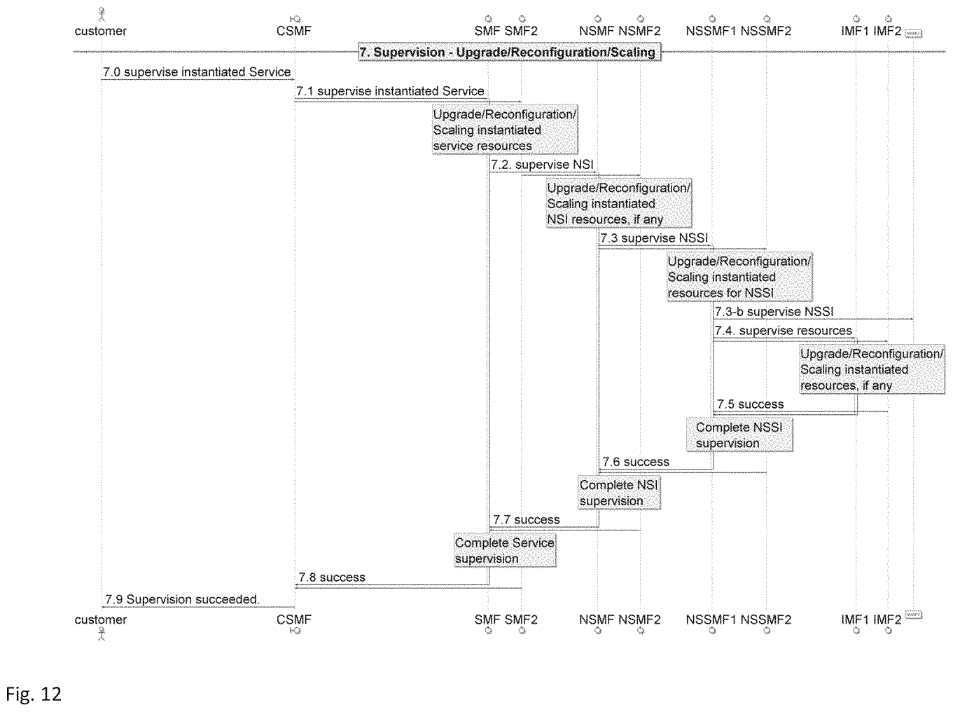

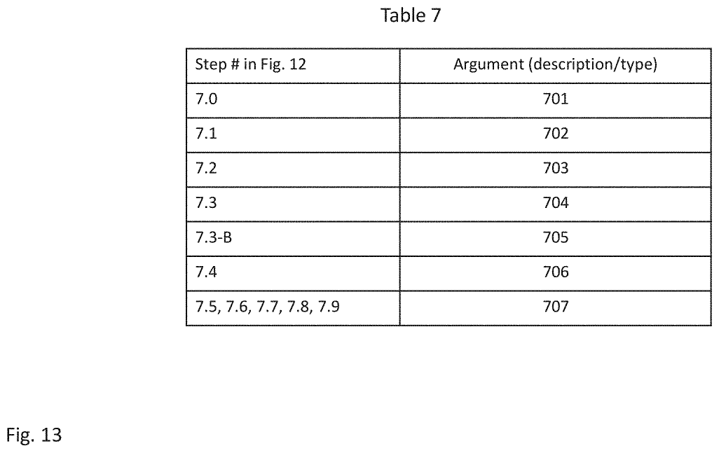

FIG. 12 shows a run-time flow illustrating the interfaces between the management functions during the supervision sub-phase of the run-time phase of the lifecycle of a network slice, according to an embodiment of the present invention.

The supervision phase occurs at any time after the reporting-monitoring phase. Based on the reported data, the SLA of each instantiated service is evaluated and the necessary supervision is started. The supervision includes upgrade, reconfiguration of specific NFs and scaling up/down, for example, the capacity for specific NFs.

FIG. 13 shows a table (denoted as Table 7) describing the arguments for supervision, according to an embodiment of the present invention

Referring to respective blocks 701 and 702 of Table 7, the argument or parameter for supervising the service at steps 7.0 and 7.1 may be an identifier (ID) of the service and the reconfiguration parameters. This includes access control parameters, end user details (such as SIM card numbers), service-related data (such as media content for a CDN service). Mainly, this request supervises the service's control and data plane with control and data plane-related reconfiguration, scaling or upgrading.

Referring to block 703 of Table 7, the argument or parameter for supervising the prepared NSI at step 7.2 may be an identifier (ID) of the NSI and as the configuration parameters of the NSI. This includes access control information of the NSI from end users as well as other operators. Mainly, this request configures the service's control and data plane with control and data plane-related reconfiguration, scaling, or upgrading functionalities.

Referring to block 704 of Table 7, the argument or parameter for supervising the prepared NSSI at step 7.3 may be an identifier (ID) of the NSSI and as the configuration parameters of the NSI. This includes access control information of the NSI from end users as well as other operators. Mainly, this request configures the service's control and data plane with control and data plane-related reconfiguration, scaling, or upgrading functionalities.

Referring to block 705 of Table 7, the argument or parameter for instantiating the prepared NSSI at step 7.3-B may be an identifier (ID) of the NSSI and as the configuration parameters of the NSI. This includes access control information of the NSI from end users as well as other operators. This step 7.3-B is required only if the NSSI in the step 7.3 or 7.3-B is further composed of NSSI. It should be noted that this step 7.3-B reflects that an NSSI can be recursively composed so that an NSSMF may also request itself or another NSSMF recursively for preparing the composed NSSI.

Referring to block 706 of Table 7, the argument or parameter for supervising the prepared resources at step 7.4 may be the access control rights to the resources and the precise connectivity details together with the ID of the resource graph (e.g., VNFFG).

Referring to block 707 of Table 7, the argument or parameter for returning a success or failure and reporting at steps 7.5 to 7.9 may be the returned success or failure, and the failure may in all cases return the reason for failure. After each one of the steps, the management function receiving the success request may further configure the managed function at its level based on the success or failure of the configuration at a lower level.

The de-commissioning phase comprises two sub-phases: the de-activation phase and the termination sub-phase.

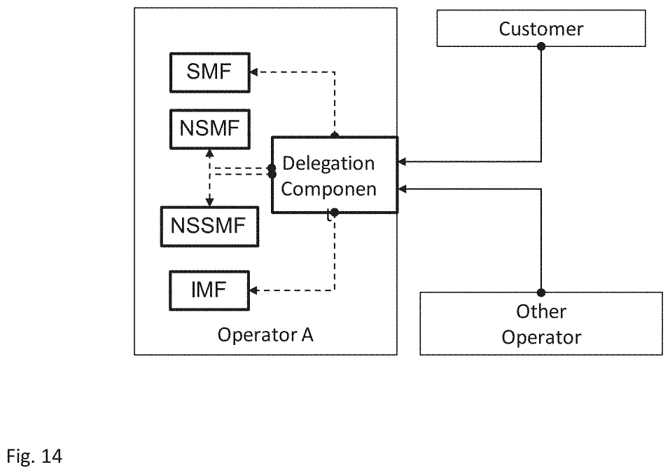

FIG. 14 shows a schematic block diagram of an operator (depicted as operator A) receiving an external slice-related service request from a customer and/or another operator, according to an embodiment of the present invention. In another embodiment, the customer may also be an operator and reciprocally. In a non-limitative embodiment, multiple customers and multiple operators may provide a respective external slice-related service request to each of them.

As an operator management system, each operator may comprise at least one delegation component (also designated as delegation entity), at least one SMF, at least one NSMF, at least one NSSMF and at least one IMF. Any one of these management functions (SMF, NSMF, NSSMF, IMF) may be collocated with any other one.

The management function may be one amongst the service management function (SMF), the network slice management function (NSMF), the network slice subnet management function (NSSMF) and the infrastructure management function (IMF), which are ordered from the highest layer management function to the lowest layer management function.

The management function may manage a respective managed entity being one amongst the sub-service or service when the management function is the SMF, the network slice instance (NSI) or slice when the management function is the NSMF, the network slice subnet instance (NSSI) or slice subnet when the management function is the NSSMF and the infrastructure when the management function is the IMF.

The management function may provide the managed entity to a higher layer management function, the sub-service or service being provided from the SMF to the customer outside the operator domain.

The delegation component may be configured to receive an incoming request from a customer outside the operator domain and/or from another operator, perform an analysis by analyzing the incoming request, and delegate, based on the analysis, the incoming request to a management function amongst the SMF, the NSMF, the NSSMF and the IMF.

The incoming request may be at least one amongst a request for hosting or providing a sub-service or service, a request for a NSI or slice, a request for a NSSI or slice subnet, a request for an infrastructure and a request for a combination thereof.

In addition, the delegation component may be an end-point providing a programmable interface into the operator in which it is hosted (i.e., the operator A when referring to FIG. 14) to any other entities external to said operator (i.e., the customer and the other operator when referring to FIG. 14).

As illustrated in the exemplary embodiment of FIG. 14, the delegation component inside the operator A may receive a respective external slice-related service request as the incoming request from the customer and the other operator. Then, the delegation component may delegate the incoming request to the SMF when the incoming request is a request for the sub-service or service, to the NSMF when the incoming request is a request for the NSI or slice, to the NSSMF when the incoming request is a request for the NSSI or slice subnet, and to the IMF when the incoming request is a request for the infrastructure. In the case where the incoming request is a request for multiple internal services amongst the sub-service or service, the NSI or slice, the NSSI or slice subnet and the infrastructure, the delegation component may delegate the incoming request to the appropriate management functions amongst the SMF, the NSMF, the NSSMF and the IMF.

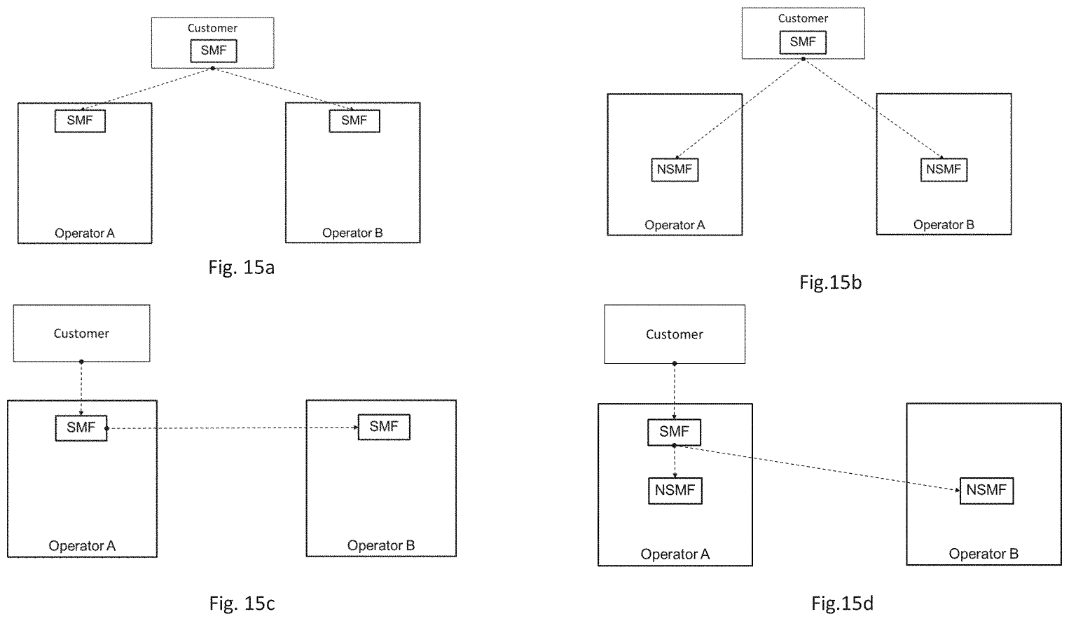

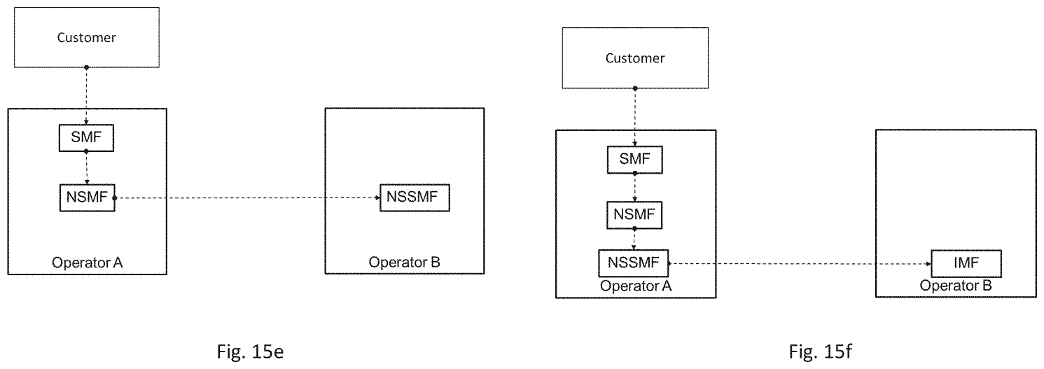

FIGS. 15a-f show multiple schematic block diagrams (numbered from 15a to 150 illustrating at least one customer outside the operator domain transmitting a respective incoming request as a request for a managed entity (sub-service or service, NSI or slice, NSSI or slice subnet, infrastructure) towards at least one operator (A, B), according to an embodiment of the present invention. For each operator (A, B), the management function managing the managed entity manages a lifecycle of the requested managed entity.

In the exemplary embodiment of FIG. 15a, the customer outside the operator domain combines the sub-services or services from different operators (operator A, operator B). In more details, the incoming request from the customer outside the operator domain is a request for a sub-service or service. The request is transmitted from the customer outside the operator domain towards two operators (operator A, operator B), wherein the SMF of each operator (A, B) manages a lifecycle of its requested sub-service or service, thereby allowing two operators (A, B) to jointly fulfill the request.

In the exemplary embodiment of FIG. 15b, the customer outside the operator domain buys complete NSIs or slices from different operators (operator A, operator B) and combines them. In more details, the incoming request from the customer outside the operator domain is a request for a NSI or slice. The request is transmitted from the customer outside the operator domain towards two operators (operator A, operator B), wherein the NSMF of each operator (A, B) manages a lifecycle of its requested NSI or slice, thereby allowing two operators (A, B) to jointly fulfill the request.

In the exemplary embodiment of FIG. 15c, the customer sees only a single sub-service or service, i.e., a sub-service or service from an underlying first operator (A), whereas the first operator (A) combines another sub-service or service from a second operator (B) in order to serve the customer by fulfilling its request. In more details, the incoming request from the customer outside the operator domain is a request for a sub-service or service. The request is transmitted from the customer outside the operator domain towards a first operator (A), wherein the SMF of the first operator (A) processes and relays the request towards a second operator (B) in the case where the first operator (A) cannot totally fulfill the request, in order to allow the SMF of the second operator (B) to manage a lifecycle of the requested sub-service or service and to fulfill the request.

In the exemplary embodiment of FIG. 15d, a first operator (A) buys a NSI or slice from a second operator (B) in order to serve the customer by fulfilling its request. In more details, the incoming request is a request for a NSI or slice. The request from the customer outside the operator domain is transmitted from the customer outside the operator domain towards a first operator (A), wherein the SMF of the first operator (A) processes and relays the request towards a second operator (B) in the case where the first operator (A) cannot totally fulfill the request, in order to allow the NSMF of the other operator (B) to manage a lifecycle of the requested NSI or slice and to fulfill the request.

In the exemplary embodiment of FIG. 15e, a first operator (A) buys a NSSI or slice subnet from a second operator (B) in order to serve the customer by fulfilling its request. In more details, the incoming request is a request for a NSSI or slice subnet. The request from the customer outside the operator domain is transmitted from the customer outside the operator domain towards a first operator (A), wherein the NSMF of the first operator (A) processes and relays the request towards a second operator (B) in the case where the first operator (A) cannot totally fulfill the request, in order to allow the NSSMF of the second operator (B) to manage a lifecycle of the requested NSSI or slice subnet and to fulfill the request.

In the exemplary embodiment of FIG. 15f, a first operator (A) buys an infrastructure (e.g., NFs, VNFs, compute, storage, networking) from a second operator (B) in order to serve the customer by fulfilling its request. In more details, the incoming request is a request for an infrastructure. The request from the customer outside the operator domain is transmitted from the customer outside the operator domain towards a first operator (A), wherein the NSSMF of the first operator (A) processes and relays the request towards a second operator (B) in the case where the first operator (A) cannot totally fulfill the request, in order to allow the IMF of the other operator (B) to manage a lifecycle of the requested infrastructure and to fulfill the request.

In summary, the present invention relates to managing a lifecycle of a managed entity inside an operator management system, i.e., one or more operator management systems, within a network slicing architecture. The managed entity is one amongst a sub-service or service, a network slice instance (NSI) or slice, a network slice subnet instance (NSSI) or slice subnet and an infrastructure, and each one is respectively managed by a management function which provides the managed entity to a higher layer management function and is one amongst a service management function (SMF), a network slice management function (NSMF), a network slice subnet management function (NSSMF) and an infrastructure management function (IMF). The operator management system further comprises a delegation entity, which is configured to receive an incoming request from a customer outside the operator management system and/or from another operator management system, perform an analysis by analyzing the incoming request, delegate, based on the analysis, the incoming request to at least one of the management functions, and be an end-point providing a programmable interface into the operator in which it is hosted towards any other entities external to said operator.

While the present invention has been illustrated and described in detail in the drawings and the foregoing description, such illustration and description are to be considered illustrative or exemplary and not restrictive. The invention is not limited to the disclosed embodiments. From reading the present disclosure, other modifications will be apparent to a person skilled in the art. Such modifications may involve other features, which are already known in the art and may be used instead of or in addition to features already described herein.

The invention has been described in conjunction with various embodiments herein. However, other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

Although the present invention has been described with reference to specific features and embodiments thereof, it is evident that various modifications and combinations can be made thereto without departing from the spirit and scope of the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A management function inside an operator management system within a network slicing architecture, the management function being configured to:
be one amongst a service management function (SMF), a network slice management function (NSMF), a network slice subnet management function (NSSMF) and an infrastructure management function (IMF), which are ordered from the highest layer management function to the lowest layer management function;
manage a respective managed entity being one amongst a sub-service or service when the management function is the SMF, a network slice instance (NSI) or slice when the management function is the NSMF, a network slice subnet instance (NSSI) or slice subnet when the management function is the NSSMF and an infrastructure when the management function is the IMF, the infrastructure comprising network functions (NFs), virtualized network functions (VNFs) and basic resources; and
provide the managed entity to a higher layer management function, the sub-service or service being provided from a service provider comprising the SMF to a customer outside the operator management system domain.

2. The management function of claim 1, wherein the managed entity has a lifecycle management comprising:
a preparation phase, which comprises a design sub-phase, an on-boarding sub-phase and a pre-provisioning sub-phase,
a deployment phase, which comprises an instantiation sub-phase, a configuration sub-phase and an activation sub-phase,
a run-time phase, which comprises a reporting and monitoring sub-phase and a supervision sub-phase; and
a de-commissioning phase, which comprises a de-activation sub-phase and a termination sub-phase.

3. The management function inside an operator management system within a network slicing architecture of claim 1 further comprising:
at least one service management function (SMF);
at least one network slice management function (NSMF);
at least one network slice subnet management function (NSSMF);
at least one infrastructure management function (IMF); and
at least one delegation entity configured to:
receive an incoming request from a customer outside the operator management system domain and/or from another operator management system;
perform an analysis by analyzing the incoming request; and
delegate, based on the analysis, the incoming request to a management function amongst the SMF, the NSMF, the NSSMF and the IMF,
wherein the delegation entity is configured to be an end-point providing a programmable interface into the operator management system in which it is hosted towards any other entities external to said operator management system.

4. The operator management system of claim 3, wherein any one of the management functions is collocated with any other management functions.

5. The operator management system of claim 3, wherein:
the incoming request is at least one amongst a request for hosting a sub-service or service, a request for a NSI or slice, a request for a NSSI or slice subnet, and a request for an infrastructure as specified; and
the incoming request comprises any combination of arguments.

6. The operator management system of any one of claim 3, wherein the delegation entity delegates the incoming request to:
the SMF when the incoming request is a request for the sub-service or service;
the NSMF when the incoming request is a request for the NSI or slice;
the NSSMF when the incoming request is a request for the NSSI or slice subnet;
the IMF when the incoming request is a request for the infrastructure; and
at least one amongst the SMF, the NSMF, the NSSMF and the IMF when the incoming request is a request for at least one amongst the sub-service or service, the NSI or slice, the NSSI or slice subnet and the infrastructure, respectively.

7. A system within a network slicing architecture, the system comprising:
at least one operator management system; and
at least one customer outside the operator management system domain,
wherein:
the at least one customer outside the operator management system domain comprises a respective service management function (SMF) as a respective customer SMF (CSMF), which manages a respective managed entity as a respective sub-service or service; and
the at least one customer outside the operator management system domain contacts the at least one operator management system by transmitting a respective incoming request.

8. The system of claim 7 when the incoming request from the at least one customer outside the operator management system domain is a request for at least one managed entity which is transmitted towards at least one operator management system, wherein, for each operator management system, the management function managing the managed entity manages a lifecycle of the requested managed entity.

9. The system of claim 8 when the incoming request from the at least one customer outside the operator management system domain is the request for a sub-service or service which is transmitted from the at least one customer outside the operator management system domain towards at least two operator management systems, wherein the SMF of each operator management system manages a lifecycle of its requested sub-service or service.

10. The system of claim 8 when the incoming request from the at least one customer outside the operator management system domain is the request for a NSI or slice which is transmitted from the at least one customer outside the operator management system domain towards at least two operator management systems, wherein the NSMF of each operator management system manages a lifecycle of its requested NSI or slice.

11. The system of claim 8 when the incoming request from the at least one customer outside the operator management system domain is the request for a sub-service or service which is transmitted from the at least one customer outside the operator management system domain towards a first operator management system, wherein one of the management functions of the single operator management system processes and relays the request towards at least one second operator management system in the case where the first operator management system cannot totally fulfill the request, in order to allow the SMF of the at least one second operator management system to manage a lifecycle of the requested sub-service or service.

12. The system of claim 8 when the incoming request from the at least one customer outside the operator management system domain is the request for a NSI or slice which is transmitted from the at least one customer outside the operator management system domain towards a first operator management system, wherein one of the management functions of the first operator management system processes and relays the request towards at least one second operator management system in the case where the first operator management system cannot totally fulfill the request, in order to allow the NSMF of the at least one second operator management system to manage a lifecycle of the requested NSI or slice.

13. The system of claim 8 when the incoming request from the at least one customer outside the operator management system domain is the request for a NSSI or slice subnet which is transmitted from the at least one customer outside the operator management system domain towards a first operator management system, wherein one of the management function of the first operator management system processes and relays the request towards at least one second operator management system in the case where the first operator management system cannot totally fulfill the request, in order to allow the NSSMF of the at least second operator management system to manage a lifecycle of the requested NSSI or slice subnet.

14. The system of claim 8 when the incoming request from the at least one customer outside the operator management system domain is the request for an infrastructure which is transmitted from the at least one customer outside the operator management system domain towards a first operator management system, wherein the first operator management system processes and relays the request towards at least one second operator management system in the case where the first operator management system cannot totally fulfill the request, in order to allow the IMF of the at least one second operator management system to manage a lifecycle of the requested infrastructure.

15. The system of any one of claim 7, wherein:
each NSMF is configured to on-board at least one network slice template (NST) allowing each NSMF to deploy and manage at least one NSI;
each NST is identified using the NST itself or a respective first identifier (ID) identifying the at least one NST;
each NSSMF is configured to on-board a respective network slice subnet descriptor (NSSD) allowing each NSSMF to deploy and manage a respective NSSI;
each NSSD is identified using the NSSD itself or a respective second identifier (ID); and
the resources managed by each IMF are identified using a respective resource description or a respective third identifier (ID).

16. A method for managing a lifecycle of a managed entity within a network slicing architecture, the method comprising the steps of:
receiving, at an operator management system, an incoming request from a customer outside the operator management system domain and/or from another operator management system, wherein the incoming request is at least one amongst a request for hosting or providing a sub-service or service, a request for a NSI or slice, a request for a NSSI or slice subnet, a request for an infrastructure and a request for a combination thereof;
performing an analysis by analyzing the incoming request; and
delegating, based on the analysis, the incoming request to a management function configured to manage the managed entity.

17. The method of claim 16 comprising the step of:
managing the lifecycle of the managed entity hosted at the operator management system receiving the incoming request.

18. The method of claim 16 comprising the steps of:
relaying the delegated incoming request towards an operator management system other than the operator management system receiving the incoming request;
performing another analysis by analyzing the relayed incoming request;
delegating, based on the analysis of the relayed incoming request, the relayed incoming request to a management function entity of the other operator management system being configured to manage the managed entity; and
managing the lifecycle of the managed entity hosted at the other operator management system receiving the relayed incoming request.

19. The method of claim 16, wherein the step of managing the lifecycle of the managed entity comprises:
a preparation phase, which comprises a design sub-phase, an on-boarding sub-phase and a pre-provisioning sub-phase;
a deployment phase, which comprises an instantiation sub-phase, a configuration sub-phase and an activation sub-phase;
a run-time phase, which comprises a reporting and monitoring sub-phase and a supervision sub-phase; and
a de-commissioning phase, which comprises a de-activation sub-phase and a termination sub-phase.

20. A computer program comprising a program code for performing the method according to claim 16 when executed on a computer.
